(19) United States
(12) Patent Application Publication
(10) Pub. No.: US 2026/0271962 A1
(43) Pub. Date: Sep. 17, 2026

(54) HIGH PROTEIN FLAKES AND METHODS OF PROCESSING THEREOF

(71) Applicant: KELLANOVA, Battle Creek, MI (US)

(72) Inventors: Roger Steven WENK, Battle Creek, MI (US); Peter ALLABAUGH, Climax, MI (US); Emanuele Russo, Battle Creek, MI (US)

(21) Appl. No.: 19/471,415

(22) PCT Filed: Apr. 5, 2024
(86) PCT No.: PCT/US2024/023253

§ 371 Date: Oct. 1, 2025

Related U.S. Application Data
(60) Provisional application No. 63/457,450, filed on Apr. 6, 2023.

(51) Int. Cl. A23J 3/16; A23J 3/18; A23J 3/26; A23L 7/122; A23L 33/155

(52) U.S. Cl. CPC A23J 3/16; A23J 3/18; A23J 3/26; A23L 7/122; A23L 33/155

(57) ABSTRACT

A method of producing high-protein flakes by preparing a first mixture by combining flour, water, pea protein nuggets, and a flavor batch. The method further includes cooking the first mixture for a first period of time. A second mixture is prepared by combining at least the first mixture and a flour batch. The flour batch includes a protein isolate, vital wheat gluten, and lentil protein. The method further includes forming protein pellets by combining the second mixture, a sweetener, and water using a cold forming extrusion process. The protein pellets are tempered and toasted to form the high-protein flakes.

### CROSS REFERENCE TO RELATED APPLICATIONS

This application claims priority under 35 U.S.C. § 119(e) to U.S. Provisional Application 63/457,450, filed on Apr. 6, 2023. The disclosures of these prior applications are considered part of the disclosure of this application and are hereby incorporated by reference in their entireties.

### FIELD

This disclosure relates to high-protein flakes, and particularly, to methods of processing high-protein flakes.

### BACKGROUND

The statements in this section merely provide background information related to the present disclosure and may not constitute prior art.

Flaked cereal products are a staple food item in many countries. The flakes are generally made of wheat, corn, oats, and the like, which provide nutritious foodstuffs to consumers. In recent years, manufacturers have become interested in providing flaked food materials that extend beyond the traditional carbohydrate-based flakes, so that other nutritious food constituents can be provided. In particular, many manufacturers would like to provide flaked food material products that include a larger amount of protein.

However, providing high protein flakes has been problematic. Both taste and mouthfeel parameters, which are necessary to provide a desirable product, have not been met when the amount of protein is increased. Additionally, high protein flakes prepared using conventional cooking techniques commonly provide flakes that are fragile and that contain multiple points of weakness, ultimately leading to unwanted cereal flake breakage.

Accordingly, it is an object of the present invention to provide a method for obtaining high protein flakes that have desirable sensorial and texture properties and that are not subject to undesirable breakage.

### SUMMARY

This section provides a general summary of the disclosure, and is not a comprehensive disclosure of its full scope or all of its features.

In some aspects a method of preparing high-protein flakes includes preparing a first mixture that includes flour, water, pea protein nuggets, and a flavor batch. The method also includes cooking the first mixture for a first period of time and preparing a flour blend that includes a protein isolate, vital wheat gluten, and lentil protein. A second mixture is prepared by combining the cooked first mixture and the flour blend. The method also includes pelletizing the second mixture using a cold forming extrusion process and forming high-protein flakes from the pellets.

The method may include one or more of the following optional steps and features. For example, the protein isolate may be an isolated soy protein powder. In some configurations, the method may include preparing the flour blend by combining the vital wheat gluten, the protein isolate, the lentil protein, and a calcium salt. The calcium salt may be calcium carbonate. Optionally, the high-protein flakes may include protein in an amount of about 20 percent by weight. In some configurations, the flavor batch may include one or more ingredients selected from water, salt, a second sweetener, or mixtures thereof. The second sweetener may be selected from one or more of (i) granulated sugar or (ii) liquid malt and corn extract. The method may also optionally include hydrating the pea protein nuggets with pressurized steam.

In some operations, the first period of time for cooking the first mixture may include three cooking cycles of about 30 minutes each. Optionally, the step of cooking the first mixture may include cooking the first mixture for a second period of time. The second period of time may be a period of about 85 minutes per cycle. The method may also include drying the cooked first mixture. In some examples, the method may include drying the protein pellets to an intermediate moisture range of about 21 percent to about 23 percent. For example, the dried protein pellets may have a moisture level of about 22 percent. In some aspects, the protein pellets may include about 42 weight percent of a combination of the protein isolate, the vital wheat gluten, the lentil protein, and calcium carbonate.

The operations may include applying a nutritional coating to the high-protein flakes. For example, the nutritional coating may be about 14.47 weight percent of the high-protein flakes. The nutritional coating may include a nutritional batch including one or more of a vitamin D blend, a vitamin B1 and vitamin B12 mix, water, or combinations thereof. In other aspects, toasting the protein pellets may include toasting the protein pellets at about 204 degrees C. Optionally, the high-protein flakes may include less than about 10 weight percent of sugar. In some examples, the first mixture is cooked at a pressure of approximately 117 kilopascals and temperature of approximately 121° C.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1 is a flow chart showing methodology for aspects of the present disclosure.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

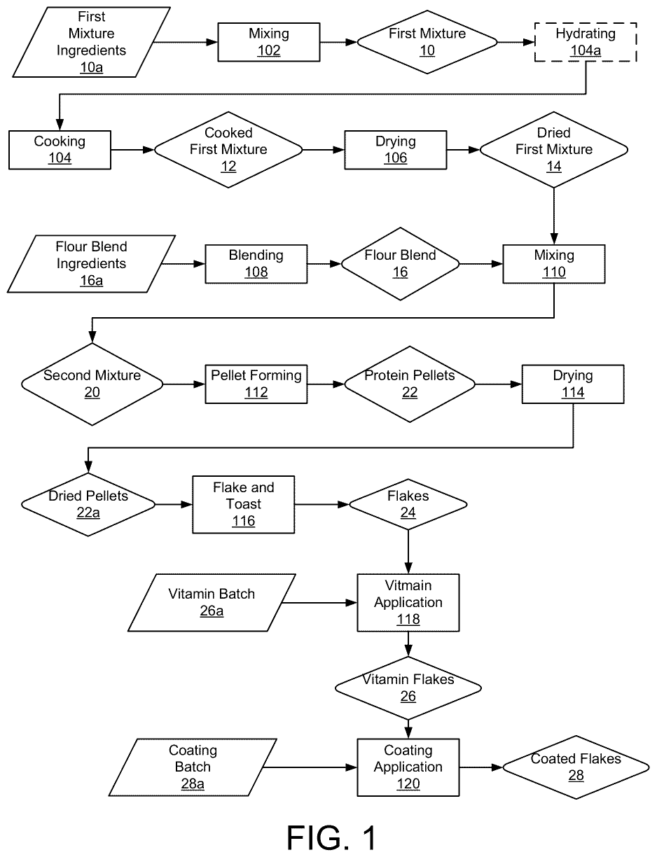

With reference to FIG. 1, the present disclosure relates to a flaked high-protein food product having a total protein content of at least of at least approximately 20 grams per 100 grams (i.e., 20 weight percent (wt %)) of the food product. Generally, the food product is a flaked food product, whereby a mixture of ingredients is cooked to form the final food product. For example, the food product is a flaked cereal product, such as a ready-to-eat cereal, formed with high-protein flakes. As described below, the food product may also include additives that supplement the high-protein flakes in final form. The food product of the present disclosure is prepared in a multistage process, whereby a first mixture 10 is prepared in a first stage using a first combination of ingredients 10a, and then a second mixture 20 is prepared in a second stage using a second combination of ingredients including the first mixture 10.

In a first step 102, the first mixture 10 is prepared by combining a first group of ingredients 10a including flour, protein, a binder, a flavor batch, rice, and water. Examples of formulations for the first mixture 10 is shown in Table 1, below.

TABLE 1
First Mixture

| | % Weight | % Weight | % Weight |
|---|---|---|---|
| Ingredient | Example 1 | Example 2 | Example 3 |
| Medium Grain Milled Rice High | 25-45% | 27-31% | 29.04% |
| Brokens | | | |
| Soft White Wheat | 20-35% | 21-25% | 23.7% |
| Flavor Batch | 25-40% | 30-35% | 33.38% |
| Pea Protein Nuggets | 5-15% | 6-8% | 6.59% |
| Light Soft White Winter Wheat Bran | 2-8% | 4-6% | 4.93% |
| Wheat Premix | 0-2% | 0-1% | 0.05% |
| Water | 0-5% | 1-2% | 2.31% |

In the example of the first mixture 10 provided in Table 1, the protein source includes pea protein nuggets. However, the protein source can be chosen from, but not limited to, egg albumen, whey protein, soy protein, vital wheat gluten, peanut protein, or mixtures thereof.

The flavor batch may include a sweetener, salt, and water. Examples of formulations for the flavor batch are shown in Table 2, below.

TABLE 2
Flavor Batch

| | % Weight | % Weight | % Weight |
|---|---|---|---|
| Ingredient | Example 1 | Example 2 | Example 3 |
| Water | 50-70% | 60-65% | 62.56% |
| Granulated Sugar | 20-40% | 30-35% | 32.82% |
| Liquid Malt & Corn Extract | 0-5% | 1-3% | 2.75% |
| Salt, Granulated, Non-iodized | 1-6% | 1-3% | 1.87% |

In this example, the sweetener includes granulated sugar and a liquid malt and corn extract. In other examples, the sweetener may be chosen from, but is not limited to, sucrose, dextrose, fructose, lactose, malt syrup, malt syrup solids, rice syrup solids, rice syrup, invert sugar, malt syrup, malt syrup solids, refiners syrup, corn syrup, corn syrup solids, maltose, high fructose corn syrup, honey, molasses, glycyrrhizin, arabinose, galactose, glucose, mannitol, maple syrup, ribose, saccharin, xylose, artificial sweeteners, or mixtures thereof. Further examples of sweeteners include brownulated sugar, evaporated cane syrup crystals, and granulated sugar. The salt may be chosen from, but is not limited to, sodium chloride, potassium chloride, calcium chloride, or mixtures thereof. In some embodiments, the salt is a granulated, non-iodized salt.

The wheat premix referenced in Table 1 may be formed from ingredients including, but not limited to, niacinamide, pyridoxine hydrochloride, riboflavin, folic acid, and iron powder. Examples of the formulations for the wheat premix is shown in Table 3, below.

TABLE 3
Wheat Premix

| | % Weight | % Weight | % Weight |
|---|---|---|---|
| Ingredient | Example 1 | Example 2 | Example 3 |
| Iron Powder | 60-90% | 78-82% | 81% |
| Niacinamide (B3) | 10-20% | 14-16% | 15% |
| Pyridoxine Hydrochloride (B6) | 0-5% | 1-3% | 2% |
| Riboflavin (B2) | 0-3% | 0-1% | 1.2% |
| Folic Acid | 0-2% | 0-1% | 0.8% |

Referring again to Table 1, the flour of the first mixture 10 includes a wheat flour. However, in other examples, the flour may include all-purpose flour, hard wheat flour, whole wheat flour, soft wheat flour, corn flour, oat flour, rice flour, barley flour, or mixtures thereof.

The first group of ingredients 10a is mixed for a first mixing period to form the first mixture 10. The first group of ingredients 10a may be mixed using conventional mixing methods and systems. Prior to mixing, the protein may optionally go through a hydrating process 104a using pressurized steam using conventional cooking methods, such as a commercial rotary steam pressure cooker. The protein is cooked for a period ranging from about 20 minutes to about 30 minutes at a steam pressure ranging from about 2 psig (13.8 kPa) to about 30 psig (206.8 kPa). The cooking temperature will depend on the steam pressure and is determined by steam tables, but typically ranges from about 120° C. to about 140° C. The protein hydrating process may occur over a period of time to hydrate the protein prior to combination into the first mixture 10. For example, the hydrating process may last a period of at least 10 minutes, preferably from 10 minutes to 30 minutes, and more preferably 20 minutes.

In another step 104, the first mixture 10 is cooked for a period of time using conventional cooking methods and systems, such as a rotary cooker. The first mixture 10 may be cooked at a pressure of 17 psig (117 kPa) and approximately 121° C. At such cooking parameters, cooking durations of 40 minutes to 100 minutes, and more preferably 55 minutes to 85 minutes, and more preferably 55 minutes or 85 minutes have been found suitable. Upon completion of the cooking step 104, the cooked first mixture 12 may have a moisture percentage of at least 30 percent, preferably 31 percent to 33 percent, and more preferably 32 percent. Optionally, the cooking step 104 may be conducted at different temperatures and/or pressures to modify the cooking cycle time.

The cooked first mixture 12 is then dried in a drying step 106 to a moisture content of at least 23 percent, preferably 24 percent to 26 percent, and more preferably 25 percent to form a dried first mixture 14. Here, the cooked first mixture 12 is inserted into a conventional dryer operating at a temperature of about 54° C. to about 74° C. The first mixture 12 is preferably dried at a temperature of about 54° C. to about 66° C., and more preferably at a temperature of about 60° C. A drying time period may range from about 40 minutes to about 90 minutes. In some embodiments, the drying time period may range from about 42 minutes to about 60 minutes or may range from about 60 minutes to about 85 minutes.

In another step 108, a flour blend 16 is prepared by combining flour blend ingredients 16a that include vital wheat gluten, a protein isolate, lentil protein, and a calcium salt. The calcium salt may assist in managing the pH level of the food matrix when later combined with the dry, cooked first mixture 14. Examples of formulations for the flour blend 16 are shown in Table 4, below.

TABLE 4
Flour Blend

| | % Weight | % Weight | % Weight |
|---|---|---|---|
| Ingredient | Example 1 | Example 2 | Example 3 |
| Isolated Soy Protein | 45-65% | 55-59% | 58.21% |
| Lentil Protein | 15-25% | 18-21% | 20.79% |
| Vital Wheat Gluten | 12-18% | 15-17% | 16.63% |
| Calcium Carbonate | 0-8% | 3-5% | 4.37% |

In another mixing step 110, the flour blend 16 is combined with the dried first mixture 14 to form the second mixture 20. The second mixture 20 includes the dry, cooked first mixture 14, the flour blend 16, water, and an optional sweetener. Examples of formulations for the second mixture 20 are shown in Table 5, below. As shown, the flour blend 16 may be provided to the second mixture 20 at a ratio of about 0.4 to 0.6, and preferably 0.565, of the first mixture 14. As a result, the flour blend 16 is provided in an amount of approximately 32.49 wt % of the second mixture 20.

TABLE 5
Second Mixture

| | % Weight | % Weight | % Weight |
|---|---|---|---|
| Ingredient | Example 1 | Example 2 | Example 3 |
| Dry, Cooked First Mixture | 45-65% | 55-59% | 57.5% |
| Flour Blend | 25-35% | 30-33% | 32.49% |
| Water | 5-15% | 7-12% | 10.01% |
| Sugar Solution | 0-8% | 0-1% | 0% |

At step, 112, the second mixture 20 is formed into protein pellets 22 using a conventional cereal pelletizer. Here, the protein pellets 22 can be formed using a cold forming process. In some embodiments, the protein pellets 22 have an overall protein content of at least about 30%, 40%, 50%, 60%, 70%, 80%, 90%, 95%, or more protein by weight of the protein pellet 22. In other embodiments, the pellets 22 have an overall protein content of about 30-95%, about 40-95%, about 60-90%, about 75-90%, about 80-90%, about 90-99%, about 95-99%, or about 95-97% by weight of the protein pellet 22.

In another drying step 114, the protein pellets 22 formed with the second mixture 20 are dried to an intermediate moisture with a pellet temperature ranging from about 40° C. to about 60° C., more preferably at a temperature of about 45° C. The intermediate moisture may include at least 20 wt %, preferably 21 wt % moisture to 23 wt % moisture, and more preferably 22 wt % moisture. The dried protein pellets 22a are then added to a flaking mill in a flaking and toasting step 116, such as a conventional flaking mill used to form conventional ready-to-eat cereal flakes. The flaking process forms the high-protein flakes 24 from the protein pellets 22. The high-protein flakes 24 are dried and toasted in a conventional hot air impingement type oven to a moisture content of about 1 wt % to about 5 wt %, preferably about 2.5 wt % to about 3.5 wt %, and more preferably about 3 wt %. The high-protein flakes 24 may be toasted at a temperature of about 100° C. to about 250° C., preferably at about 200° C. The finished high-protein flakes 24 have a structural integrity, texture, size, shape, and overall appearance similar to conventional ready-to-eat cereal flakes. The high-protein flakes 24 have at least 15 grams of protein per serving, preferably 20 grams of protein per serving.

In some embodiments, the method includes a vitamin application step 118, which includes applying a vitamin coating to the high-protein flakes 26. Coating processes used for conventional ready-to-eat cereals can be used. The nutritional coating is formed from a nutritional or vitamin batch 26a that may include a vitamin D blend, a premix of vitamins B1 and B12, and water. Examples of formulations for the nutritional batch 26a is shown in Table 6, below.

TABLE 6
Nutritional Batch

| | % Weight | % Weight | % Weight |
|---|---|---|---|
| Ingredient | Example 1 | Example 2 | Example 3 |
| Water | 70-99% | 95-99% | 97.61% |
| Vitamin D Blend | 0-4% | 1-3% | 2.28% |
| Vitamin B1 and B12 Spray | 0-2% | 0-1% | 0.09% |

The nutritional batch 26a may include vitamins, antioxidants, minerals, trace elements, fibers, and mixtures thereof. The vitamins may include vitamin A, B1 (thiamin), B2 (riboflavin), B6, B12, C, D, E and/or derivative thereof, niacin, folic acid, biotin, and pantothenic acid in a nutritionally acceptable form and amount. Examples of mineral and trace elements include calcium, iron, phosphorous, iodine, magnesium, manganese, zinc, copper, sodium, choline, potassium, selenium, and chromium in a nutritionally acceptable form and amount. Suitable antioxidants include alpha-tocopherol, citric acid, butylated hydroxytoluene, butylated hydroxyanisole, ascorbic acid, fumaric acid, malic acid, sodium ascorbate, and ascorbic acid palmitate in a nutritionally acceptable form and amount.

Referring again to Table 6, the vitamin D blend may be formed from polysorbate, propylene glycol dicaprylate, mono and diglycerides, corn oil, cholecalciferol, or mixtures thereof. The vitamin B1 and B12 premix may be formed from thiamin hydrochloride, cyanocobalamin, or mixtures thereof. The nutritional batch 26a may be applied using conventional spray techniques. For example, the spray nozzle used to apply the vitamin batch 26a may be a single air atomizing nozzle. The nutritional batch 26a is applied with a weight of at least 0.01 kilograms per kilogram of toasted flakes, more preferably of about 0.02 kilograms to 0.03 kilograms per kilogram of toasted flakes 24. Finally, a coating batch 28a may be applied to the high-protein flakes 26 during a coating application step 120. The coating batch 28a may be formed from water, sucrose, natural flavors, and salt. Examples of formulations for the coating batch 28a is shown in Table 7, below.

TABLE 7
Coating Batch

| | % Weight | % Weight | % Weight |
|---|---|---|---|
| Ingredient | Example 1 | Example 2 | Example 3 |
| Granulated Sugar | 45-65% | 54-58% | 55.74% |
| Water | 25-40% | 32-34% | 33.28% |
| Cocoa Powder | 3-8% | 4-6% | 5.82% |
| Chocolate Liquor | 2-6% | 3-5% | 4.16% |
| Salt, Non-iodized | 0-2% | 0-1% | 1.01% |

The coating batch 28a is applied to the high-protein flakes 24 at the end of the formation process. A liquid flavor may be injected separate from the coating batch 28a. The coating batch 28a may be applied at a ratio with the high-protein flakes 24 of about 0.1765 to 1. In other examples, the coating batch 28a may be applied at a ratio of about 0.1, or about 0.11, or about 0.12, or about 0.13, or about 0.14, or about 0.15, or about 0.16, or about 0.17, or about 0.18, or about 0.19 to 1.

The coated high-protein flakes 28 may be packaged as a ready-to-eat cereal, which, in some embodiments, may also include additional additives. Optionally, additives, such as sliced almonds, may be included with the high-protein flakes 28. The additives may be included and distributed with a ratio of at least 0.1 to 1 with the high-protein flakes 28. In other examples, the coating batch 28a may be applied at a ratio of about 0.1, or about 0.11, or about 0.12, or about 0.13, or about 0.14, or about 0.15, or about 0.16, or about 0.17, or about 0.18, or about 0.19 to 1. Preferably, the additives may be included and distributed with a ratio of about 0.1765 to 1 with the high-protein flakes 28.

The final high-protein flakes 28 include about 20 wt % of protein with preferably less than about 10 wt % of sugar per serving. As mentioned herein, the protein pellets 22 used to form the high-protein flakes 28 may be formed using a cold forming extrusion process, such that the flour batch 16a generally remains uncooked prior to the pellet forming process 112. The cold forming extrusion process advantageously promotes the use of various protein compounds in the flour blend 16, including the vital wheat gluten, the lentil protein, and the protein isolate. Each of the protein compounds maintains a respective functional ingredient for the high-protein flakes 28 as a result of the cold forming extrusion process. For example, the first mixture 10 is cooked separate from the second mixture 20 to preserve the protein compositions found in the flour batch 16a. Further, the blend of proteins used in forming the high-protein flakes 28 provides a lesser degree of potential degradation during the toasting process while providing a greater degree of functional ingredients, specifically protein, to the high-protein flakes 28.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of preparing high-protein flakes, the method comprising:
preparing a first mixture including flour, water, pea protein nuggets, and a flavor batch;
cooking the first mixture for a first period of time;
preparing a flour blend including a protein isolate, vital wheat gluten, and lentil protein;
preparing a second mixture by combining the cooked first mixture and the flour blend;
pelletizing the second mixture using a cold forming extrusion process; and
forming high-protein flakes from the pellets.

2. The method of claim 1, wherein the protein isolate is an isolated soy protein powder.

3. The method of claim 1, further including preparing the flour blend by combining the vital wheat gluten, the protein isolate, the lentil protein, and a calcium salt.

4. The method of claim 3, wherein the calcium salt is calcium carbonate.

5. The method of claim 1, wherein the high-protein flakes include protein in an amount of about 20 percent by weight.

6. The method of claim 1, wherein the flavor batch includes one or more ingredients selected from water, salt, a second sweetener, or mixtures thereof.

7. (canceled)

8. The method of claim 1, further including hydrating the pea protein nuggets with pressurized steam.

9. The method of claim 1, wherein the first period of time for cooking the first mixture includes three cooking cycles of about 30 minutes each.

10. The method of claim 1, wherein cooking the first mixture includes cooking the first mixture for a second period of time.

11. The method of claim 10, wherein the second period of time is a period of about 85 minutes per cycle.

12. The method of claim 1, further including drying the cooked first mixture.

13. The method of claim 1, further including drying the protein pellets to an intermediate moisture range of about 21 percent to about 23 percent.

14. The method of claim 13, wherein the dried protein pellets have a moisture level of about 22 percent.

15. The method of claim 1, wherein the protein pellets include about 42 weight percent of a combination of the protein isolate, the vital wheat gluten, the lentil protein, and calcium carbonate.

16. The method of claim 1, further including applying a nutritional coating to the high-protein flakes.

17. The method of claim 16, wherein the nutritional coating is about ranges from 14 weight percent to 15 weight percent of the high-protein flakes.

18. The method of claim 16, the nutritional coating includes a nutritional batch comprised of one or more of a vitamin D blend, a vitamin B1 and vitamin B12 mix, water, or combinations thereof.

19. The method of any of claim 1, wherein toasting the protein pellets includes toasting the protein pellets at about 204 degrees C.

20. The method of claim 1, wherein the high-protein flakes include less than about 10 weight percent of sugar.

21. The method of claim 1, wherein the first mixture is cooked at a pressure of approximately 117 kilopascals and temperature of approximately 121° C.
